(19) United States
(12) Patent Application Publication
(10) Pub. No.: US 2026/0010140 A1
(43) Pub. Date: Jan. 8, 2026

(54) SIMULATION DEVICE AND COMPUTER PROGRAM

(71) Applicant: FANUC CORPORATION, Yamanashi (JP)

(72) Inventors: Kojiro ARIMATSU, Yamanashi (JP); Tarou OGISO, Yamanashi (JP)

(73) Assignee: FANUC CORPORATION, Yamanashi (JP)

(21) Appl. No.: 19/117,436

(22) PCT Filed: Mar. 22, 2024
(86) PCT No.: PCT/JP2024/011494

§ 371 Date: Apr. 1, 2025

(51) Int. Cl. G05B 19/4069

(52) U.S. Cl. CPC G05B 19/4069; G05B 2219/32017

(57) ABSTRACT

A simulation device for a machine tool includes: a numerical control simulation unit that generates an axis movement command for the machine tool, based on a machining program; a servocontrol simulation unit that generates a torque command, based on the axis movement command and an axis movement virtual result for simulating an axis movement of the machine tool; and a module unit that has a form independent of the numerical control simulation unit and the servocontrol simulation unit, and is replaceable, wherein the module unit includes: a transceiver unit that receives the torque command from the servocontrol simulation unit, and transmits the axis movement virtual result to the servocontrol simulation unit; and a drive shaft simulation unit that updates the axis movement virtual result, based on the torque command.

### TECHNICAL FIELD

The present disclosure relates to a simulation device and a computer program.

### BACKGROUND ART

Conventionally, movements of a machine tool that includes a plurality of drive shafts and a controller for controlling these drive shafts has been verified using a simulation device that simulates execution of a user program by the controller. Such a simulation device has a predetermined model for simulation of the drive shafts (for example, see Patent Document 1).

### CITATION LIST

### Patent Document

Patent Document 1: Japanese Patent No. 6460138

DISCLOSURE OF THE INVENTION

### Problems to be Solved by the Invention

However, the movements of the machine tool considerably relies on the properties of the drive shafts, such as the inertia, frictions, and interference of the shafts. Since the drive shafts of the machine tool have various properties, not all the drive shafts can be simulated by a fixed model. For example, according to Patent Document 1, it is not possible to simulate a drive shaft configuration which requires consideration of shaft interference and friction, and in which inertia changes depending on the state of another shaft.

As described above, the existing simulation device for a machine tool can only simulate a drive shaft using a predetermined fixed model. For this reason, a simulation device and a computer program are desired that can simulate various types of drive shafts, with models for simulation of the drive shafts being changed accordingly.

### Means for Solving the Problems

An aspect of the present disclosure is directed to a simulation device for a machine tool, including: a numerical control simulation unit that generates an axis movement command for the machine tool, based on a machining program; a servocontrol simulation unit that generates a torque command, based on the axis movement command and an axis movement virtual result for simulating an axis movement of the machine tool; and a module unit that has a form independent of the numerical control simulation unit and the servocontrol simulation unit, and is replaceable. The module unit includes: a transceiver unit that receives the torque command from the servocontrol simulation unit, and transmits the axis movement virtual result to the servocontrol simulation unit; and a drive shaft simulation unit that simulates a movement of a drive shaft of the machine tool, and updates the axis movement virtual result, based on the torque command. The module unit is generated by an external device independent of a system that controls the machine tool, and the servocontrol simulation unit generates the torque command when the axis movement virtual result is obtained, and does not generate the torque command when the axis movement virtual result is not obtained.

An aspect of the present disclosure is directed to a computer program for causing a computer to execute steps including: a step of causing a numerical control simulation unit to generate an axis movement command for a machine tool, based on a machining program; a step of causing a servocontrol simulation unit to generate a torque command, based on the axis movement command and an axis movement virtual result for simulating an axis movement of the machine tool; a step of causing a module unit to receive the torque command from the servocontrol simulation unit and transmit the axis movement virtual result to the servocontrol simulation unit, the module unit that having a form independent of the numerical control simulation unit and the servocontrol simulation unit and being replaceable; and a step of causing the module unit to simulate a movement of a drive shaft of the machine tool and update the axis movement virtual result, based on the torque command. The module unit is generated by an external device independent of a system that controls the machine tool, and the torque command is generated when the axis movement virtual result is obtained, and the torque command is not generated when the axis movement virtual result is not obtained.

### BRIEF DESCRIPTION OF THE DRAWINGS

FIG. 1 is a functional block diagram showing an overview of a simulation device according to a first embodiment;

FIG. 2 shows a correspondence relationship between an actual machine tool and the simulation device;

FIG. 3 is a block diagram of a transfer function in a simulation example by the simulation device;

FIG. 4 shows an operation example of the simulation device according to the first embodiment;

FIG. 5 is a functional block diagram showing an overview of a simulation device according to a second embodiment;

FIG. 6 shows an example of calculating a corrected axis movement virtual result according to the second embodiment;

FIG. 7 shows an example of calculating the corrected axis movement virtual result according to the second embodiment;

FIG. 8 shows an example of predicting the axis movement virtual result shown in FIG. 6;

FIG. 9 is a functional block diagram showing an overview of a simulation device according to a third embodiment;

FIG. 10 shows an overview of a simulation device according to a fourth embodiment;

FIG. 11 shows an example of tandem control; and

FIG. 12 shows an example of lathe machining.

### PREFERRED MODE FOR CARRYING OUT THE INVENTION

### First Embodiment

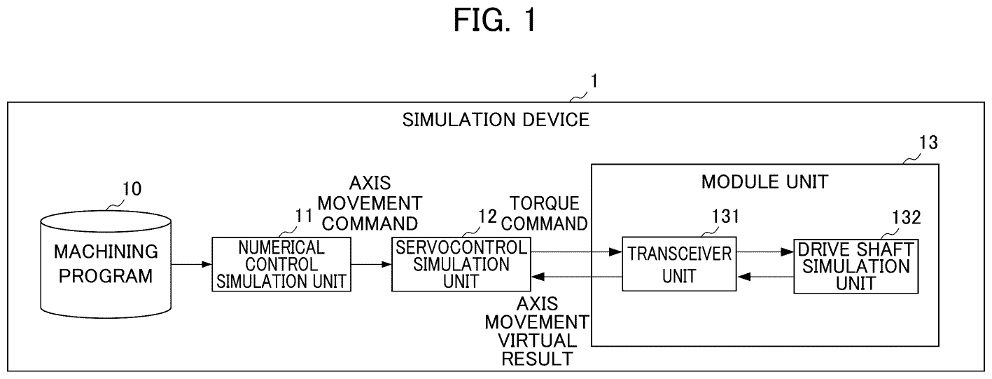

Examples of embodiments of the present disclosure are described below. FIG. 1 shows an overview of a simulation device 1 according to a first embodiment. The simulation device 1 simulates movements of a machine tool that includes a drive shaft, and a controller that controls the drive shaft. The simulation device 1 may be, for example, a computer device or the like connected to the machine tool and a numerical control device. The simulation device 1 may be a computer device that is for simulation and is not connected to the machine tool and the numerical control device.

The simulation device 1 includes a numerical control simulation unit 11, a servocontrol simulation unit 12, and a module unit 13.

The numerical control simulation unit 11 is a functional unit that simulates CNC (Computer Numerical Control) control for the machine tool. The numerical control simulation unit 11 generates an axis movement command for the drive shaft of the machine tool, based on a machining program 10.

The servocontrol simulation unit 12 is a functional unit that simulates servomotor control for the machine tool. The servocontrol simulation unit 12 generates a torque command, based on the axis movement command for the drive shaft of the machine tool and an axis movement virtual result for simulating the axis movement of the drive shaft of the machine tool.

Here, the axis movement virtual result includes an axis movement virtual result initial value acquired by the servocontrol simulation unit 12 only for an initial movement, and an axis movement virtual result updated value updated by a drive shaft simulation unit. The axis movement virtual result initial value may be provided from the numerical control simulation unit 11, stored in another database (not shown), or set in the module unit 13. For example, as for the axis movement virtual result initial value, the last position at the last activation is provided as the initial value. The axis movement virtual result may be any of the position of the drive shaft, the speed of the drive shaft, the acceleration of the drive shaft, and the amount of movement of the drive shaft.

The module unit 13 has a form independent of the numerical control simulation unit 11 and the servocontrol simulation unit 12, and is replaceable. The module unit 13 is, for example, a file, an application, or the like in a format, such as a DLL (dynamic link library), or .exe (executable form), which can be individually dealt with on a computer. The module unit 13 may be a storage medium such as a USB memory or an SD card, a microcomputer or the like, and store a file in a format of DLL or .exe, an application or the like that can be individually dealt with.

The module unit 13 includes a transceiver unit 131, and a drive shaft simulation unit 132. The transceiver unit 131 receives the torque command from the servocontrol simulation unit 12, and transmits the axis movement virtual result to the servocontrol simulation unit 12. The drive shaft simulation unit 132 simulates the movement of the drive shaft of the machine tool, and updates the axis movement virtual result, based on the torque command.

The module unit 13 is generated by an external device independent of a system that controls the machine tool. The servocontrol simulation unit 12 generates the torque command when the axis movement virtual result is obtained, and does not generate the torque command when the axis movement virtual result is not obtained. The system that controls the machine tool may be, for example, an operating system that controls the machine tool, an operating system of the simulation device for simulating the movement of the machine tool, or an application program. The external device is a computer device or an application program that can communicate with the simulation device 1. The external device may be a computer device or an application program that can transmit and receive data to and from the simulation device 1 via a storage medium, such as a USB memory or an SD card.

Note that as for the calculation cycle of the numerical control simulation unit 11, the calculation cycle of the servocontrol simulation unit 12, and the calculation cycle of the drive shaft simulation unit 132 described above, even if the calculation cycles are different from each other in communication between the numerical control simulation unit 11, the servocontrol simulation unit 12, and the drive shaft simulation unit 132, the operation is achieved without any problem.

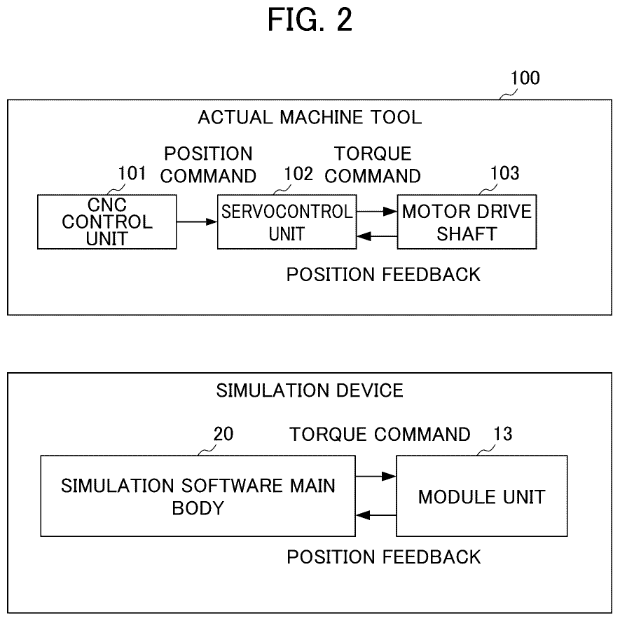

FIG. 2 shows the correspondence relationship between an actual machine tool 100 and the simulation device 1. As shown in FIG. 2, the actual machine tool 100 includes, for example, a CNC (Computer Numerical Control) control unit 101, a servocontrol unit 102, and a motor drive shaft 103. The CNC control unit 101 outputs a position command to the servocontrol unit 102. The servocontrol unit 102 outputs the torque command to the motor drive shaft 103, based on the position command. The motor drive shaft 103 drives the shaft, based on the torque command, and outputs, to the servocontrol unit 102, position feedback output from a detector, such as a rotary encoder.

On the other hand, the simulation device 1 includes: a simulation software main body 20 corresponding to the numerical control simulation unit 11, the servocontrol simulation unit 12 and the like; and the module unit 13 that stores therein the drive shaft simulation unit 132 and the like.

The simulation software main body 20 outputs the torque command to the module unit 13 in order to simulate the actual machine tool 100 described above. The module unit 13 executes simulation, based on the torque command, and outputs the position feedback to the simulation software main body 20. Here, the module unit 13, which stores the drive shaft simulation unit 132 and the like, is created in conformity with the corresponding machine by a machine tool builder and a user of the machine tool. Consequently, the model of the drive shaft simulated by the drive shaft simulation unit 132 may include drive shafts having various properties.

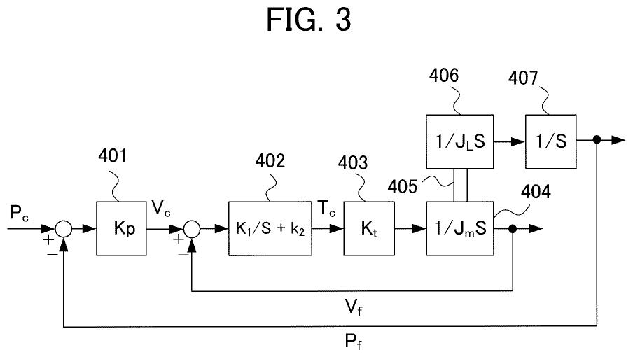

FIG. 3 is a block diagram of a transfer function in a simulation example by the simulation device 1. Specifically, FIG. 3 is a block diagram of a transfer function in an example where the drive shaft serves as a feed shaft, the axis movement is simulated by the simulation device 1.

The simulation device 1 performs simulation of a movement of the feed shaft that draws a path based on the machining program and a movement of a main spindle that rotates a tool or a workpiece. For example, in the case where the shaft is a feed shaft, the simulation device 1 is indicated by the block diagram of the transfer function in FIG. 3. Block diagrams of configurations similar to the configuration of the block diagram of FIG. 3 are disclosed in Japanese Unexamined Patent Application, Publication No. H3-110607, PCT International Publication No. WO2023/157244, etc. The transfer function of the drive shaft simulation unit 132 is configured by coupling of transfer functions 401 through 407.

In FIG. 3, the transfer function 401 is a transfer function of a position loop, and Kp denotes a position gain. The transfer function 402 is a transfer function of a speed loop, k₁ denotes an integral gain, and k₂ denotes a proportional gain. The transfer functions 403 and 404 are transfer functions of motors. Kₜ denotes a torque constant, and Jₘ denotes a motor inertia (inertia moment). The transfer function 405 indicates a ball screw or the like that is a coupling part between a servomotor and the machine. The transfer function 406 is a transfer function of the machine, and J_{L} denotes the inertia of the machine. The transfer function 407 is a transfer function of an integrator element that integrates the speed of a movable part of the machine, and obtains the position of the machine.

The position loop indicated by the transfer function 401 and the speed loop indicated by the transfer function 402 serve as servocontrol models. The motor, the ball screw and the like, and the integrator element indicated by the transfer functions 403, 404, 405, 406, and 407 serve as plant models.

A position error is obtained by subtracting, from the position command, a feedback signal P_{f} of the position of the machine detected by a linear scale or the like, and a speed command V_{c} is obtained by multiplying the position error by the position gain Kp. A speed error is obtained by subtracting, from the speed command V_{c}, a feedback value V_{f} of the motor speed detected by a pulse coder or the like attached to the servomotor, and is subjected to proportional integral, thus obtaining a torque command T_{C} (current command). The servomotor is driven based on the torque command T_{c}. The position and speed of the servomotor are subjected to feedback control according to a closed loop scheme.

The simulation device 1 may have a configuration in which the transfer function 407 integrates the angular speed of the servomotor and obtains the angle of the servomotor and in which a value obtained by converting the angle of the servomotor into the position of the machine is regarded as the position of the machine. The transfer functions 404, 405, 406, and 407 described above correspond to simulation by the drive shaft simulation unit 132.

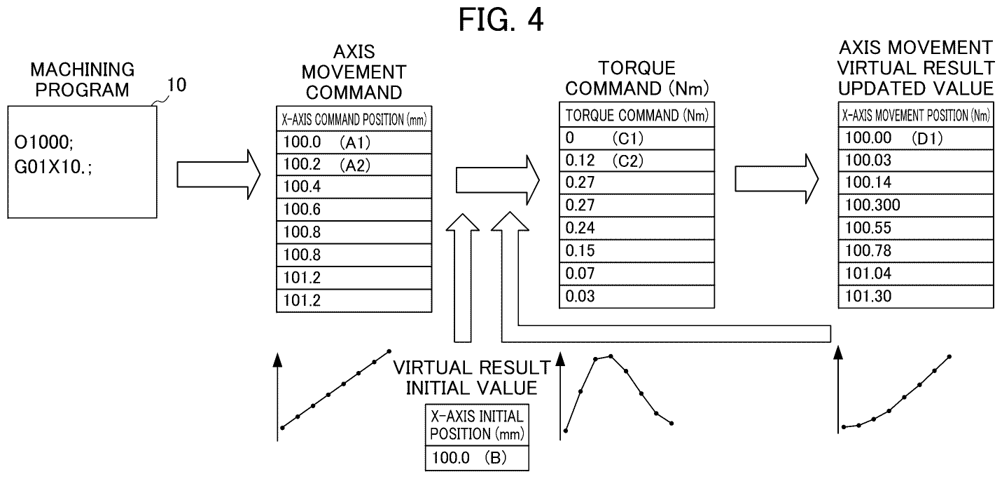

FIG. 4 shows an operation example of the simulation device 1 according to the first embodiment. As described above, the numerical control simulation unit 11 generates an axis movement command for the drive shaft of the machine tool, based on the machining program 10. The servocontrol simulation unit 12 generates the torque command, based on the axis movement command and the axis movement virtual result. The drive shaft simulation unit 132 updates the axis movement virtual result, based on the torque command.

That is, as shown in FIG. 4, the servocontrol simulation unit 12 generates a torque command C1, based on an X-axis command position A1 as an axis movement command, and on an X-axis initial position B as an axis movement virtual result initial value, according to the machining program 10. The servocontrol simulation unit 12 then generates a torque command C2, based on an X-axis command position A2 and an X-axis movement position D1 as an updated value of the axis movement virtual result. Here, the servocontrol simulation unit 12 does not generate the torque command C2 if the X-axis movement position D1 that is the axis movement virtual result is not obtained. As described above, the torque command and the axis movement virtual result are sequentially generated and updated by the servocontrol simulation unit 12 and the drive shaft simulation unit 132.

As described above, according to the first embodiment, the simulation device 1 includes: the numerical control simulation unit 11 that generates the axis movement command for the machine tool, based on the machining program 10; the servocontrol simulation unit 12 that generates the torque command, based on the axis movement command and the axis movement virtual result for simulating the axis movement of the machine tool; and the module unit 13 that has a form independent of the numerical control simulation unit 11 and the servocontrol simulation unit 12, and is replaceable. The module unit 13 includes: the transceiver unit 131 that receives the torque command from the servocontrol simulation unit 12, and transmits the axis movement virtual result to the servocontrol simulation unit 12; and the drive shaft simulation unit 132 that simulates the movement of a drive shaft of the machine tool, and updates the axis movement virtual result, based on the torque command. The module unit 13 is generated by an external device independent of a system that controls the machine tool, and the servocontrol simulation unit 12 generates the torque command when the axis movement virtual result is obtained, and does not generate the torque command when the axis movement virtual result is not obtained.

With such a configuration provided, the simulation device 1 according to the first embodiment can change the model of the simulation of the drive shaft so as to enable simulation of various types of drive shafts. Furthermore, the simulation device 1 can independently develop simulation in conformity with the properties of drive shafts. Accordingly, simulation in which the properties of the drive shaft is reflected can be achieved by the developed simulation.

The axis movement virtual result includes the axis movement virtual result initial value acquired by the servocontrol simulation unit 12 only for the initial movement, and the axis movement virtual result updated value updated by the drive shaft simulation unit 132. Accordingly, in the simulation device 1, the servocontrol simulation unit 12 generates the torque command even at the initial movement, and simulation by the drive shaft simulation unit 132 can be performed.

### Second Embodiment

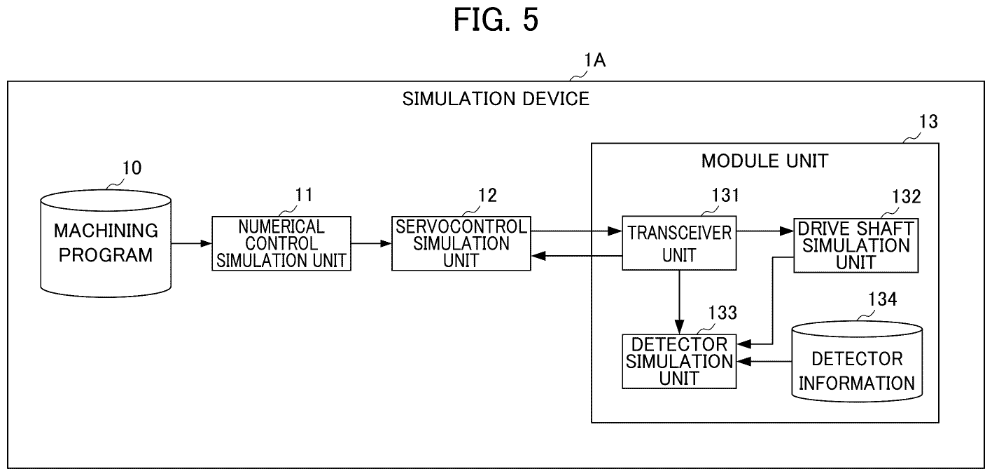

FIG. 5 is a functional block diagram showing an overview of a simulation device 1A according to a second embodiment. Note that in description of the second embodiment, differences from the first embodiment are mainly described, and description of components and processes similar to those in the first embodiment is omitted.

The simulation device 1A according to the second embodiment further includes a detector simulation unit 133 that corrects the axis movement virtual result, based on detector information 134 on the machine tool. The transceiver unit 131 transmits the corrected axis movement virtual result to the detector simulation unit 133.

Here, the detector information 134 at least includes the calculation cycle of the drive shaft simulation unit 132, the amount of delay of the calculation result, the resolution of a detector of the drive shaft (simulation target), and the amount of delay of feedback due to transmission and reception of data.

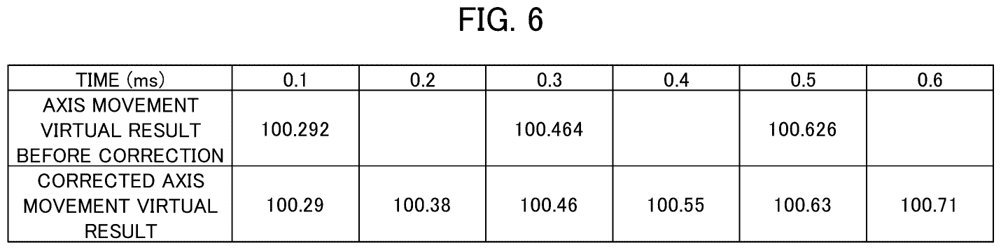

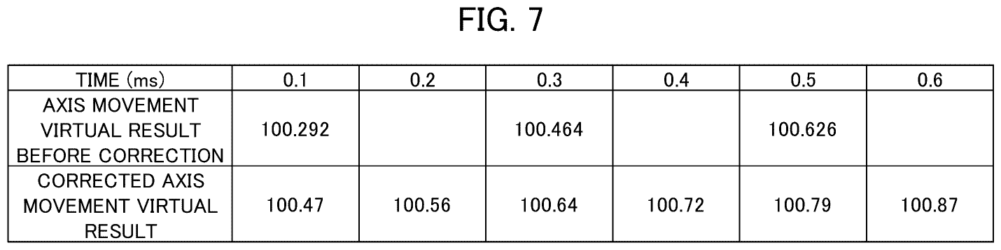

FIGS. 6 and 7 show examples of calculating the corrected axis movement virtual result according to the second embodiment. Specifically, FIGS. 6 and 7 show the axis movement virtual result before correction that is output from the drive shaft simulation unit 132, and the corrected axis movement virtual result that is output from the detector simulation unit 133.

In the example shown in FIG. 6, as for the detector information, the resolution is 0.01 deg, and the calculation cycle of the drive shaft simulation unit 132 is 0.2 ms. In FIG. 6, the axis movement virtual result at time −0.1 ms is 100.113.

In the case of performing calculation of the drive shaft every 0.2 ms to reduce the amount of calculation in response to the torque command every 0.1 ms, the detector simulation unit 133 predicts each missing axis movement virtual result, based on the immediately previous axis movement virtual result.

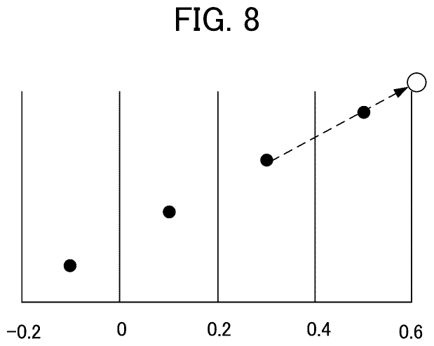

FIG. 8 shows an example of predicting the axis movement virtual result shown in FIG. 6. For example, as shown in FIG. 8, a corrected axis movement virtual result at 0.6 ms in FIG. 6 is obtained from an axis movement virtual result (100.626) at 0.5 ms having not been corrected yet, and an axis movement virtual result (100.464) at 0.3 ms having not been corrected yet.

More specifically, the corrected axis movement virtual result at 0.6 ms in FIG. 6 is obtained as 100.626+1/2(100.626−100.464)=100.71. Likewise, the corrected axis movement virtual result at 0.2 ms in FIG. 6 is obtained as 100.292+1/2*(100.292−100.113)=100.38. The corrected axis movement virtual result at 0.4 ms is obtained as 100.464+1/2*(100.464−100.292)=100.55.

The example shown in FIG. 7 is a case where in addition to the example in FIG. 6, a 0.2 ms subsequent axis movement virtual result is obtained, for calculation reasons. In the example shown in FIG. 7, as for the detector information, the resolution is 0.01 deg, the calculation cycle of the drive shaft simulation unit 132 is 0.2 ms, and the delay is 0.2 ms. In FIG. 7, the axis movement virtual result at time −0.1 ms is 100.113.

In such a case, in response to the torque command every 0.1 ms, the detector simulation unit 133 predicts each missing axis movement virtual result based on the immediately previous axis movement virtual result.

For example, the corrected axis movement virtual result at 0.1 ms in FIG. 7 is obtained from an axis movement virtual result (100.292) at 0.1 ms having not been corrected yet, and an axis movement virtual result (100.113) at −0.1 ms having not been corrected yet. More specifically, the corrected axis movement virtual result at 0.1 ms in FIG. 7 is obtained as 100.292+2/2*(100.292−100.113)=100.47. The corrected axis movement virtual results at 0.3 ms and 0.5 ms are obtained in the same manner.

The corrected axis movement virtual result at 0.2 ms is obtained as 100.292+3/2*(100.292−100.113)=100.56. The corrected axis movement virtual results at 0.4 ms and 0.6 ms are also obtained in the same manner.

In the examples shown in FIGS. 6 and 7, if the axis movement virtual result is not corrected, the servocontrol simulation unit 12 stops every 0.2 ms, and correct simulation cannot be achieved in some cases. In the examples described above, the corrected axis movement virtual result is unintermittent. Accordingly, the servocontrol simulation unit 12 outputs the torque command every 0.1 ms without any problem.

As described above, according to the second embodiment, the module unit 13 further includes a detector simulation unit 133 that corrects the axis movement virtual result, based on detector information 134 on the machine tool. Accordingly, even if the calculation cycle of the numerical control simulation unit 11, the calculation cycle of the servocontrol simulation unit 12, and the calculation cycle of the drive shaft simulation unit 132 are different from each other, the simulation device 1A can perform interpolation against the difference in calculation cycle.

The detector information 134 at least includes the calculation cycle of the drive shaft simulation unit 132, the amount of delay of the calculation result, the resolution of the detector for the drive shaft, and the amount of delay of feedback. Accordingly, the simulation device 1A can perform interpolation against effects of the calculation cycle, the resolution, the amount of delay and the like.

### Third Embodiment

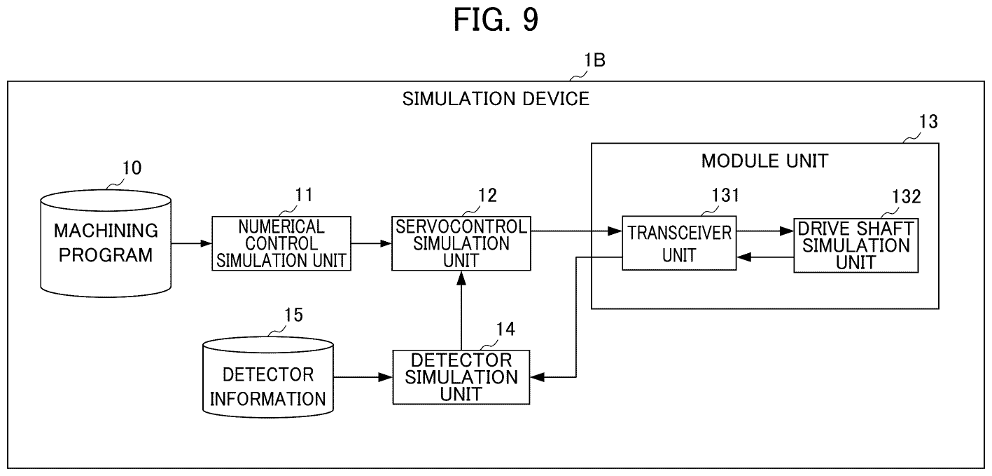

FIG. 9 is a functional block diagram showing an overview of a simulation device 1B according to a third embodiment. Note that in description of the third embodiment, differences from the first and second embodiments are mainly described, and description of components and processes similar to those in the first and second embodiments is omitted.

The simulation device 1B according to the third embodiment further includes a detector simulation unit 14 that corrects the axis movement virtual result, based on detector information 15 on the machine tool. The transceiver unit 131 transmits the corrected axis movement virtual result to the detector simulation unit 133. That is, the simulation device 1B according to the third embodiment includes the detector simulation unit 14 and the detector information 15 instead of the detector simulation unit 133 and the detector information 134 according to the second embodiment.

Here, similar to the second embodiment, the detector information 15 at least includes the calculation cycle of the drive shaft simulation unit 132, the amount of delay of the calculation result, the resolution of the detector of the drive shaft, and the amount of delay of feedback.

As described above, according to the third embodiment, the simulation device 1B further includes the detector simulation unit 133 that corrects the axis movement virtual result, based on the detector information 134 on the machine tool, and the transceiver unit 131 transmits the corrected axis movement virtual result to the detector simulation unit 133. Accordingly, even if the calculation cycle of the numerical control simulation unit 11, the calculation cycle of the servocontrol simulation unit 12, and the calculation cycle of the drive shaft simulation unit 132 are different from each other, the simulation device 1B can perform interpolation against the difference in calculation cycle.

### Fourth Embodiment

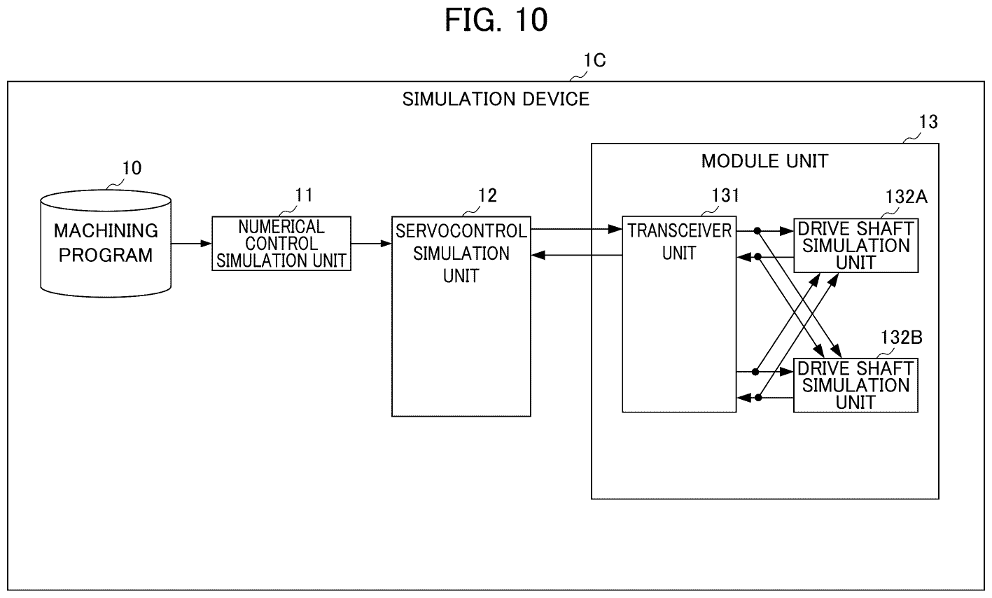

FIG. 10 shows an overview of a simulation device 1C according to a fourth embodiment. Note that in description of the fourth embodiment, differences from the first, second, and third embodiments are mainly described, and description of components and processes similar to those in the first, second, and third embodiments is omitted. The simulation device 1C according to the fourth embodiment includes drive shaft simulation units 132A and 132B.

In the case of simulation of a drive mechanism drive by a plurality of (e.g., two) motors, the drive shaft simulation units 132A and 132B execute simulation, based on a torque command for another shaft of the machine tool or the axis movement virtual result of the other shaft.

Specifically, the drive shaft simulation unit 132A executes simulation, based on the torque command output to the drive shaft simulation unit 132B or on the axis movement virtual result output to the transceiver unit 131. Likewise, the drive shaft simulation unit 132B executes simulation, based on the torque command output to the drive shaft simulation unit 132A or on the axis movement virtual result output to the transceiver unit 131.

A drive mechanism driven by a plurality of motors include tandem control, lathe machining performed by a main spindle and a feed shaft, etc.

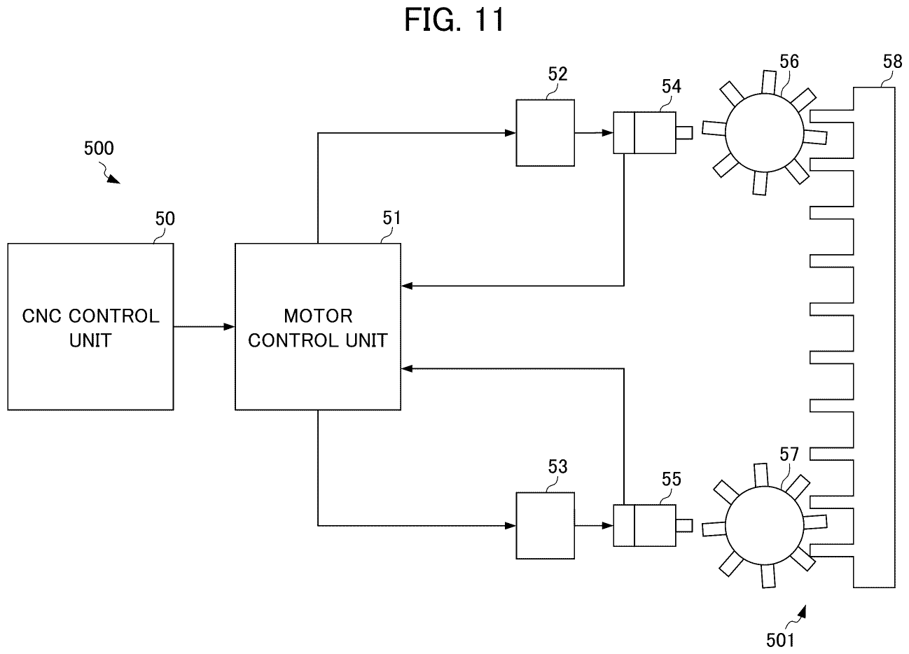

FIG. 11 shows an example of tandem control. A control device 500 shown in FIG. 11 is for tandem control in which a single drive mechanism 501 is driven by a plurality of (two) motors 54 and 55. The drive mechanism 501 is a machine tool made up of a movable object 58 and machine parts 56 and 57, such as gears. To the movable object 58, a drive force is transmitted from the motor 54 via the machine part 56, and a drive force of the motor 55 is transmitted via the machine part 57.

The control device 500 includes a CNC control unit 50, and a motor control unit 51. The CNC control unit 50 performs various processes for operating the drive mechanism 501. The motor control unit 51 performs current control for the motor 54 via an amplifier 52, based on a command from the CNC control unit 50, and performs current control for the motor 55 via an amplifier 53. The motors 54 and 55 are servomotors. The motor control unit 4 receives feedback signals for obtaining the positions and speeds from the motors 54 and 55.

As shown in FIG. 11, in tandem control in which the single drive mechanism 501 is driven by the two motors 54 and 55, the movement of one motor changes an external force applied to the other motor. Accordingly, in the case of simulation of the drive mechanism 501, the simulation device 1C can use the torque command for or the axis virtual result of another shaft.

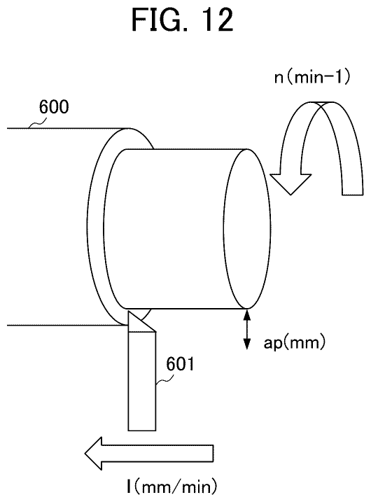

FIG. 12 shows an example of lathe machining. In general, it is supposed that the cutting resistance main component (cutting resistance of a main spindle 600 in the rotational direction) is proportional to the cutting cross-sectional area. Accordingly, the cutting resistance main component in lathe machining as in FIG. 12 can be calculated by the following expression.

$$F = \frac{ap \cdot l \cdot Kc}{n} ( N ) \qquad [ Expression 1 ]$$

Here, ap (mm) denotes the amount of cutting, 1 (mm/min) denotes the feed speed of a linear shaft, Kc (MPa) denotes the specific cutting resistance, and n (min−1) denotes the rotational speed of the main spindle rotational speed. As in the expression described above, in lathe machining, the cutting reaction force (F) of the main spindle 600 is affected by the feed speed (1) of feeding of the linear shaft 601. Accordingly, to correctly simulate the main spindle 600, the simulation device 1C can use the axis movement virtual result (speed) of the linear shaft 601, which is the other shaft.

As described above, according to the fourth embodiment, to simulate the drive mechanism driven by a plurality of motors, the drive shaft simulation units 132A and 132B execute simulation, based on the torque command for another shaft of the machine tool, or the axis movement virtual result of the other shaft. Accordingly, the simulation device 1C can perform correct simulation in consideration of the interference with the other drive shaft.

While the embodiments of the present invention have thus been described above, the aforementioned simulation device 1 can be implemented by hardware, software, or a combination of them. A control method performed by the simulation device 1 described above can also be implemented by hardware, software, or a combination of them. Here, the implementation by software means that a computer reads and executes a program for the implementation.

The program can be stored using any of various types of non-transitory computer readable media, and supplied to the computer. The non-transitory computer readable media include various types of tangible storage media. Examples of the non-transitory computer readable media include a magnetic recording medium (e.g., a hard disk drive), a magnetooptical recording medium (e.g., a magnetooptical disk), a CD-ROM (Read Only Memory), a CD-R, a CD-R/W, semiconductor memories (e.g., a mask ROM, and a PROM (Programmable ROM), an EPROM (Erasable PROM), a flash ROM, and a RAM (random access memory)).

While the present disclosure has thus been described in detail, the present disclosure is not limited to the aforementioned individual embodiments. These embodiments can undergo various additions, replacements, changes, or partial removals, in a range without deviating from the gist of the present disclosure, or in a range without deviating from the spirit of the present disclosure derived from the content described in the claims and their equivalents. These embodiments may be implemented in a combined manner. For example, in the embodiments described above, the order of the operations, and the orders of the processes are described as examples. There is no limitation to them. This also applies in cases where numerical values and mathematical expressions are used for the description of the aforementioned embodiments.

The following further discloses additional remarks regarding the foregoing embodiments and modification examples thereof.

### Additional Remark 1

A simulation device (1) for a machine tool, including:
a numerical control simulation unit (11) that generates an axis movement command for the machine tool, based on a machining program (10);
a servocontrol simulation unit (12) that generates a torque command, based on the axis movement command and an axis movement virtual result for simulating an axis movement of the machine tool; and
a module unit (13) that has a form independent of the numerical control simulation unit (11) and the servocontrol simulation unit (12), and is replaceable. The module unit (13) includes:
a transceiver unit (131) that receives the torque command from the servocontrol simulation unit (12), and transmits the axis movement virtual result to the servocontrol simulation unit (12); and
a drive shaft simulation unit (132) that simulates a movement of a drive shaft of the machine tool, and updates the axis movement virtual result, based on the torque command.

The module unit (13) is generated by an external device independent of a system that controls the machine tool. The servocontrol simulation unit (12) generates the torque command when the axis movement virtual result is obtained, and does not generate the torque command when the axis movement virtual result is not obtained.

### Additional Remark 2

In the simulation device (1) according to Additional Remark 1, the axis movement virtual result includes an axis movement virtual result initial value acquired by the servocontrol simulation unit (12) only for an initial movement, and an axis movement virtual result updated value updated by the drive shaft simulation unit (132).

### Additional Remark 3

In the simulation device (1) according to Additional Remark 1 or 2, the module unit (13) further includes a detector simulation unit (133) that corrects the axis movement virtual result, based on detector information (134) on the machine tool.

### Additional Remark 4

The simulation device (1) according to Additional Remark 1 or 2 further includes a detector simulation unit (14) that corrects the axis movement virtual result, based on detector information (15) on the machine tool, and
the transceiver unit (131) transmits the axis movement virtual result corrected, to the detector simulation unit (14).

### Additional Remark 5

In the simulation device (1) according to Additional Remark 3, the detector information includes at least a calculation cycle of the drive shaft simulation unit (132), an amount of delay of a calculation result, a resolution of a detector for a drive shaft, and an amount of delay of feedback.

### Additional Remark 6

In the simulation device (1) according to Additional Remark 1 or 2, in a case of simulation of a drive mechanism driven by a plurality of motors, the drive shaft simulation unit (132) executes simulation, based on the torque command for another shaft of the machine tool or the axis movement virtual result of the other shaft.

### Additional Remark 7

A computer program for causing a computer to execute steps comprising: a step of causing a numerical control simulation unit (11) to generate an axis movement command for a machine tool, based on a machining program; a step of causing a servocontrol simulation unit (12) to generate a torque command, based on the axis movement command and an axis movement virtual result for simulating an axis movement of the machine tool; a step causing a module unit (13) to receive the torque command from the servocontrol simulation unit (12) and transmit the axis movement virtual result to the servocontrol simulation unit (12), the module unit (13) having a form independent of the numerical control simulation unit (11) and the servocontrol simulation unit (12) and being replaceable; and a step of causing the module unit (13) to simulate a movement of a drive shaft of the machine tool and update the axis movement virtual result, based on the torque command. The module unit (13) is generated by an external device independent of a system that controls the machine tool, and the torque command is generated when the axis movement virtual result is obtained, and the torque command is not generated when the axis movement virtual result is not obtained.

### EXPLANATION OF REFERENCE NUMERALS

1, 1A, 1B, 1C simulation device
10 machining program
11 numerical control simulation unit
12 servocontrol simulation unit
13 module unit
14, 133 detector simulation unit
15, 134 detector information
131 transceiver unit
132, 132A, 132B drive shaft simulation unit

1. A simulation device for a machine tool, comprising:
a numerical control simulation unit that generates an axis movement command for the machine tool, based on a machining program;
a servocontrol simulation unit that generates a torque command, based on the axis movement command and an axis movement virtual result for simulating an axis movement of the machine tool; and
a module unit that has a form independent of the numerical control simulation unit and the servocontrol simulation unit, and is replaceable, wherein
the module unit includes:
a transceiver unit that receives the torque command from the servocontrol simulation unit, and transmits the axis movement virtual result to the servocontrol simulation unit; and
a drive shaft simulation unit that simulates a movement of a drive shaft of the machine tool, and updates the axis movement virtual result, based on the torque command.

2. The simulation device according to claim 1, wherein the axis movement virtual result includes an axis movement virtual result initial value acquired by the servocontrol simulation unit only for an initial movement, and an axis movement virtual result updated value updated by the drive shaft simulation unit.

3. The simulation device according to claim 1, wherein the module unit further includes a detector simulation unit that corrects the axis movement virtual result, based on detector information on the machine tool.

4. The simulation device according to claim 1, further comprising: a detector simulation unit that corrects the axis movement virtual result, based on detector information on the machine tool,
wherein the transceiver unit transmits the axis movement virtual result corrected, to the detector simulation unit.

5. The simulation device according to claim 3, wherein the detector information includes at least a calculation cycle of the drive shaft simulation unit, an amount of delay of a calculation result, a resolution of a detector for a drive shaft, and an amount of delay of feedback.

6. The simulation device according to claim 1, wherein in a case of simulation of a drive mechanism driven by a plurality of motors, the drive shaft simulation unit executes simulation, based on the torque command for another shaft of the machine tool or the axis movement virtual result of the other shaft.

7. A computer program for causing a computer to execute steps comprising:
a step of causing a numerical control simulation unit to generate an axis movement command for a machine tool, based on a machining program;
a step of causing a servocontrol simulation unit to generate a torque command, based on the axis movement command and an axis movement virtual result for simulating an axis movement of the machine tool;
a step of causing a module unit to receive the torque command from the servocontrol simulation unit and transmit the axis movement virtual result to the servocontrol simulation unit, the module unit having a form independent of the numerical control simulation unit and the servocontrol simulation unit and being replaceable; and
a step of causing the module unit to simulate a movement of a drive shaft of the machine tool and update the axis movement virtual result, based on the torque command.

8. A simulation device for a machine tool, comprising:
a simulation software main body that generates a torque command, based on an axis movement command for simulating CNC (Computer Numerical Control) for machine tool and an axis movement virtual result for simulating an axis movement of the machine tool; and
a module unit that has a form independent of the simulation software main body, and is replaceable,
wherein the module unit simulates a movement of a drive shaft of the machine tool, and outputs the axis movement virtual result, based on the torque command.

9. The computer program according to claim 7, wherein
the computer program is stored on a non-transitory computer-readable storage medium and is executed by a computer that comprises a processor.
